(19) United States
(12) Patent Application Publication
(10) Pub. No.: US 2012/0171891 A1
(43) Pub. Date: Jul. 5, 2012

(54) PLUG

(75) Inventors: Kazuhiro Katou, Osaka (JP); Maki Kondou, Mie City (JP); Takashi Kawamoto, Mie City (JP); Toshiyuki Takii, Mie City (JP); Satoru Ueno, Osaka City (JP)

(73) Assignee: PANASONIC CORPORATION, Osaka (JP)

(21) Appl. No.: 13/389,357

(22) PCT Filed: Aug. 3, 2010
(86) PCT No.: PCT/IB2010/001905

§ 371 Date: Mar. 23, 2012

(30) Foreign Application Priority Data
Aug. 7, 2009 (JP) 2009-185057
Aug. 7, 2009 (JP) 2009-185059
Aug. 7, 2009 (JP) 2009-185060
Aug. 7, 2009 (JP) 2009-185061
Aug. 7, 2009 (JP) 2009-185280
Sep. 25, 2009 (JP) 2009-221515
Sep. 25, 2009 (JP) 2009-221618
Nov. 24, 2009 (JP) 2009-266751

(51) Int. Cl. H01R 13/64

(52) U.S. Cl. 439/374

(57) ABSTRACT

A plug, adapted to be connected to a direct current (DC) outlet for supplying a DC power thereto, includes a plurality of round bar-shaped plug pins which protrudes from a front surface of a plug main body, and a surrounding wall which protrudes from the front surface of the plug main body to surround the plug pins. The plug pins are adapted to be connected the pin-receiving pieces through pin insertion holes of the DC outlet and to be supplied with power from the DC outlet. The surrounding wall is adapted to be inserted into an insertion groove of the DC outlet which is formed around the pin-insertion holes. The surrounding wall is formed in a substantially quadrangular shape, viewed from a front side thereof. The plug pins are arranged along a reference surface corresponding to one inner surface of the surrounding wall and offset closer to the reference surface than to an inner surface opposite to the reference surface.

### FIELD OF THE INVENTION

The present invention relates to a plug which is adapted to be connected to a direct current (DC) outlet.

### BACKGROUND OF THE INVENTION

Conventionally, there are known a DC outlet for supplying a DC power to a DC device, e.g., a radio, a television set or the like, having a DC power supply as a driving power supply, and a plug which is detachably connected to the DC outlet (see, e.g., Japanese Patent Application Publication No. H7-15835 (paragraphs [0021] to [0023], and FIG. 1) (JP7-15835A).

The DC outlet of JP07-015835A includes a main body that is accommodated in a switch box provided inside a wall; and a converter provided inside the main body to convert an AC power to a DC power. Further, the DC outlet includes an

AC connection terminal provided on a rear side of the main body which faces the switch box; and an outlet part provided on a front side of the main body which faces an inside of a room. A power line of an AC power source installed inside the wall is connected to the AC connection terminal, and a plug of an electric device is detachably connected to the outlet part. Accordingly, when the power line of the AC power source is connected to the AC connection terminal of the DC outlet, an AC power is converted to a DC power by the converter, so that the DC power can be supplied to the electric device having the plug that is connected to the outlet part thereof.

In the meantime, when a plug is connected to and disconnected from a DC outlet, an arc may be generated. Especially, in the case of the DC outlet for supplying a DC power, the generated arc may be maintained as compared with an AC outlet and, thus, the DC outlet needs an arc protecting unit. However, the DC outlet of JP07-015835A has an outlet part of a pin-jack type terminal and the plug is formed as a pin-jack type plug to be connected to the pin-jack type terminal. Thus, no member for surrounding plug pins of a plug. Accordingly, the generated arc may be seen from the outside.

As an example of a DC outlet and a DC plug including an arc protecting unit, there has been disclosed a plug and a socket of a safety extra low voltage (SELV) voltage standardized by the IEC standard (CEI/IEC 60906-3). FIGS. 15C and 15D show a plug 110 standardized by the IEC standard. Two plug pins 112 are arranged inside a cylindrical portion 111 provided at a front end portion of the plug 110.

Meanwhile, as shown in FIGS. 37A and 37B, a socket 100 includes a circular opening 101 through which the cylindrical portion 111 of the plug 110 is inserted; a cylindrical protruding portion 102 which protrudes from the circular opening 101 to be inserted into the cylindrical portion 111; pin-inserting holes 103 which are opened to an front end surface of the protruding portion 102; and pin-receiving pieces 104 provided inside the protruding portion 102 to communicate with the pin-inserting holes 103. When the plug 110 is connected to the socket 100, the plug pins 112 which are inserted into the protruding portion 102 through the pin-inserting holes 103 are respectively engaged with the pin-receiving pieces 104, so that a power is supplied from the socket 100 to the plug 110.

As shown in FIGS. 15A to 15D, in the socket 100 standardized by the IEC standard, the two pin-inserting holes 103 are opened on a line L1 extending through the center of the protruding portion 102 and at two symmetric positions with regard to the center of the protruding portion 102 and the two plug pins 112 are disposed on a line L2 extending through the center of the cylindrical portion 111 and at two symmetric positions with regard to the center of the cylindrical portion 102. For that reason, a keyway 105 is formed on a peripheral surface of the protruding portion 102 and a rib 113 is formed on an inner peripheral surface of the cylindrical portion 111 such that the plug pins 112 would not be inserted into the pin-inserting holes 103 in a state that their polarities are misaligned.

Further, the plug 110 and the socket 100 standardized by the IEC standard correspond to four kinds of supply voltages. To identify the kinds of supply voltages, the socket 100 and the plug 110 respectively include a voltage-identifying groove 106 formed on the peripheral surface of the protruding portion 102 at a predetermined angle with regard to the keyway 105; and a voltage-identifying rib 114 protrudently formed on the inner peripheral surface of the cylindrical unit 111 of the plug 110 at a predetermined angle with regard to the rib 113.

Then, the plug 110 is prevented from being inserted into the socket 100 reversely or wrongly with their polarities misaligned by engaging the keyway 105 and the voltage-identifying groove 106 with the rib 113 and the voltage-identifying rib 114, respectively. When, however, the cylindrical portion 111 is inserted into the circular opening 101, it is required to find positions at which the ribs 113 and 114 of the cylindrical portion 111 are respectively engaged with the keyway 105 and the groove 106 of the socket 100 while rotating the plug 110. Accordingly, it becomes inconvenient to use the socket 100 and the plug 110.

In the socket 100 and the plug 110 described above, in order to prevent the plug 110 from being reversely inserted into the socket 100 without using the keyway 105 and the rib 113, it is considered to arrange the two pin-inserting holes 103 at a side below or above the line L1 (e.g., at a side below the line L1) while arranging the plug pins 112 at a side below or above the line L2 (e.g., at a side below the line L2) as shown in FIGS. 15A and 15C by the dotted lines). Since, however, the cylindrical portion 111 has the cylindrical shape, the distance between the plug pins 112 becomes closer when the plug pins 112 are arranged at a side below or above line L2. Accordingly, the plug 110 becomes scaled up in order to obtain an insulating distance.

### SUMMARY OF THE INVENTION

In view of the above, the present invention provides a plug capable of preventing its reverse insertion into a DC outlet without being scaled up and being easily aligned with the DC outlet when the plug is connected thereto.

In accordance with an aspect of the present invention, there is provided a plug which is adapted to be connected to a direct current (DC) outlet for supplying a DC power thereto, the DC outlet having an insertion groove formed around a plurality of pin insertion holes opened at a front side and having therein pin-receiving pieces corresponding to the pin insertion holes, the plug including: a plurality of round bar-shaped plug pins which protrudes from a front surface of a plug main body, the plug pins being adapted to be connected the pin-receiving pieces through the pin insertion holes of the DC outlet and to be supplied with power from the DC outlet; and a surrounding wall which protrudes from the front surface of the plug main body to surround the plug pins, the surrounding wall being adapted to be inserted into the insertion groove of the DC outlet, wherein the surrounding wall is formed in a substantially quadrangular shape, viewed from a front side thereof, and the plug pins are arranged along a reference surface corresponding to one inner surface of the surrounding wall and offset closer to the reference surface than to an inner surface opposite to the reference surface.

The shape of the surrounding wall, viewed from the front side thereof, may be partially changed depending on the kinds of a supply voltage, a supply current or a power supply circuit.

Further, the shape of the surrounding wall viewed from the front side may be changed such that an area of a portion surrounded by the surrounding wall is decreased compared to a case that the surrounding wall has the substantially quadrangular shape viewed from the front side. In this case, the shape of the surrounding wall viewed from the front side may be partially changed by cutting at least one corner of the substantially quadrangular shape of the surrounding wall depending on the kinds of the supply voltage, supply current or power supply circuit.

Preferably, a portion of the surrounding wall whose shape is changed depending on the kinds of the supply voltage, supply current or power supply circuit is closer to the inner surface opposite to the reference surface than the reference surface.

Alternatively, the shape of the surrounding wall viewed from the front side may be changed such that an area of a portion surrounded by the surrounding wall is increased as compared with a case that the surrounding wall has the substantially quadrangular shape viewed from the front side.

Further, the shape of the surrounding wall viewed from the front side may be partially changed by forming an extended portion protruding from a surface of the surrounding wall. In this case, the extended portion extends inward from an inner surface the surrounding wall. Preferably, the extended portion is disposed closer to a surface opposite to the reference surface of the surrounding wall. Alternatively, the extended portion may extend outward from an outer surface of the surrounding wall.

Further, the shape of the surrounding wall viewed from the front side may be partially changed only when the power supply circuit is a safety extra low voltage (SELV) circuit.

In addition, the plug pins of the plug may include a ground pin. In this case, the ground pin may be provided offset closer to the inner surface opposite to the reference surface.

Furthermore, the plug main body may include: a box-shaped front case having an open rear portion, the surrounding wall being provided on a front surface of the front case; and a box-shaped rear case having an open front portion, the rear case being fixed to the front case so as to block the rear opening of the front case, wherein the plug pins are received in the front and the rear case.

Alternatively, the plug main body may include: a fixing portion for fixing the plug pins; and a housing formed at an outer side of the fixing portion by a secondary molding, the housing being made of synthetic resin, wherein the surrounding wall is formed as a unit with the housing.

In accordance with the present invention described above, the plug pins to which power is supplied are arranged along the reference surface corresponding to one inner surface of the substantially quadrangular-shaped surrounding wall and offset closer to the reference surface than to the inner surface opposite to the reference surface. Thus, it is possible to easily recognize the orientation of the plug to be inserted into the DC outlet. Further, the substantially quadrangular-shaped surrounding wall is inserted into the insertion groove of the DC outlet, so that the orientation of the plug to be inserted into the DC outlet is limited. This allows the easy position alignment of the plug and enables realization of the plug which is convenient in use and has a configuration of preventing reverse insertion. Even if the plug pins are arranged offset closer to the reference surface, the gap between the plug pins does not decrease due to the substantially quadrangular shape of the surrounding wall. Hence, it is unnecessary to scale up the plug to ensure an insulation distance.

Further, since the shape of the surrounding wall viewed from the front side is partially changed by cutting at least one of the corners of the surrounding wall depending on the kinds of supply voltage, supply current or power supply circuit, a user can easily identify the kinds of the supply voltage, supply current or power supply circuit from the shape of the surrounding wall and recognize the orientation of the plug to be inserted into the DC outlet. Accordingly, the position alignment of the plug and the DC outlet can be easily carried out.

In addition, the shape of the surrounding wall viewed from the front side is partially changed by cutting the corner(s) near the surface opposite to the reference surface of the surrounding wall, so that it is possible to obtain a sufficient distance between the plug pins and the surrounding wall compared to the case of cutting the corner(s) near the reference surface. This enables easy fabrication of the plug.

Moreover, the kinds of supply voltage, supply current or power supply circuit can be identified by the extended portion protruding from the surface of the surrounding wall. The extended portion extends from the surface of the surrounding wall, so that the extended portion has a sufficient strength compared to a case that it is formed separately from the surrounding wall.

Besides, by forming the extended portion at the inner surface, scaling up of the plug can be prevented compared to a case that the extended portion is formed at the outer surface of the surrounding wall.

Further, by forming the extended portion at the inner surface of the surrounding wall close to the surface opposite to the reference surface of the surrounding wall, it is possible to obtain a sufficient distance between the plug pins and the surrounding wall including the extended portion compared to a case that the extended portion is formed close to the reference surface. This enables easy fabrication of the plug.

### BRIEF DESCRIPTION OF THE DRAWINGS

The other objects and features of the present invention will become apparent from the following description of embodiments, given in conjunction with the accompanying drawings, in which:

FIGS. 1A and 1B depict a plug in accordance with a first embodiment of the present invention, wherein FIG. 1A is a perspective view seen from the front, and FIG. 1B is a perspective view seen from the rear which depicts a state before the plug is connected to a DC outlet;

FIGS. 2A to 2C illustrate a DC outlet to which the plug is connected, wherein FIG. 2A is a top view, FIG. 2B is a right side view and FIG. 2C is a partial bottom section view;

FIGS. 3A to 3E show front views of a plug in accordance with a second embodiment of the present invention;

FIGS. 4A to 4C show a modification of the plug in accordance with the second embodiment of the present invention;

FIGS. 5A to 5D present front views of a plug in accordance with a third embodiment of the present invention;

FIGS. 6A to 6E represent front views of another example of the plug;

FIG. 7 depicts a configuration of a DC power distribution system using the plug;

FIGS. 8A and 8B shows a plug in accordance with a fourth embodiment of the present invention, wherein FIG. 8A is a perspective view seen from the front, and FIG. 8B is a perspective view seen from the rear which depicts a state before the plug is connected to a DC outlet;

FIGS. 9A to 9C are a front view, a right side view and a bottom view of the plug of the fourth embodiment;

FIG. 10 is an exploded perspective view of the plug of the fourth embodiment;

FIGS. 11A and 11C show a contactor block of the plug of the fourth embodiment, wherein FIG. 11A is a perspective view seen from the front, FIG. 11B is a perspective view seen from the rear and FIG. 11C is an exploded perspective vies seen from the rear;

FIGS. 12A and 12B shows a plug in accordance with a fifth embodiment of the present invention, wherein FIG. 8A is a perspective view seen from the front, and FIG. 8B is a perspective view seen from the rear which depicts a state before an outer case is formed by a secondary molding;

FIG. 13 is a perspective view of the plug of the fifth embodiment having a ground pin;

FIGS. 14A to 14D explain a case where plug pins of a plug have a flat-blade shape; and

FIGS. 15A to 15D illustrate a plug and a socket for an SELV circuit standardized by IEC standard, wherein FIGS. 9A and 9C are respectively front views of the socket and the plug, and FIGS. 9B and 9D are respectively cross sectional views of the socket and the plug.

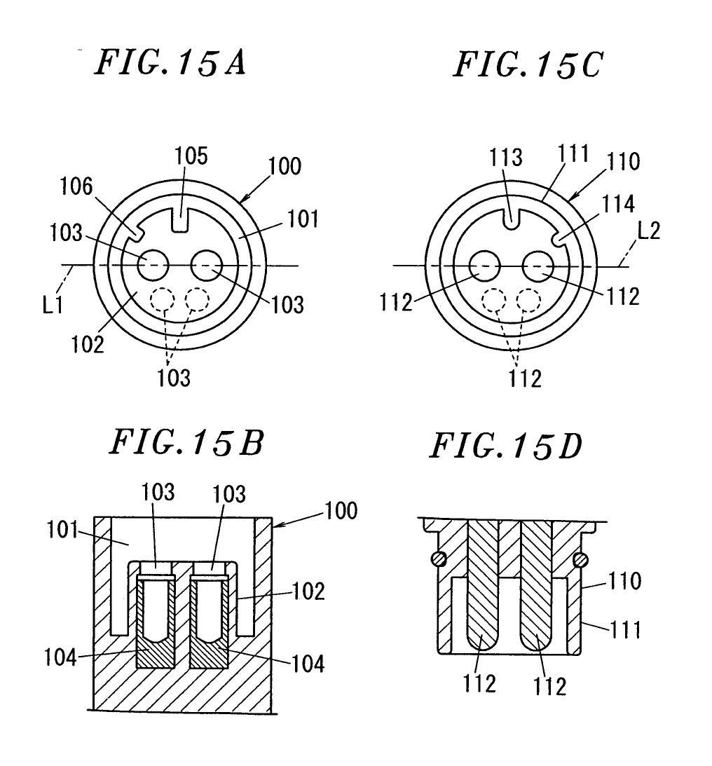

### DETAILED DESCRIPTION OF THE EMBODIMENT

Embodiments of the present invention will now be described with reference to the accompanying drawings which form a part hereof.

### First Embodiment

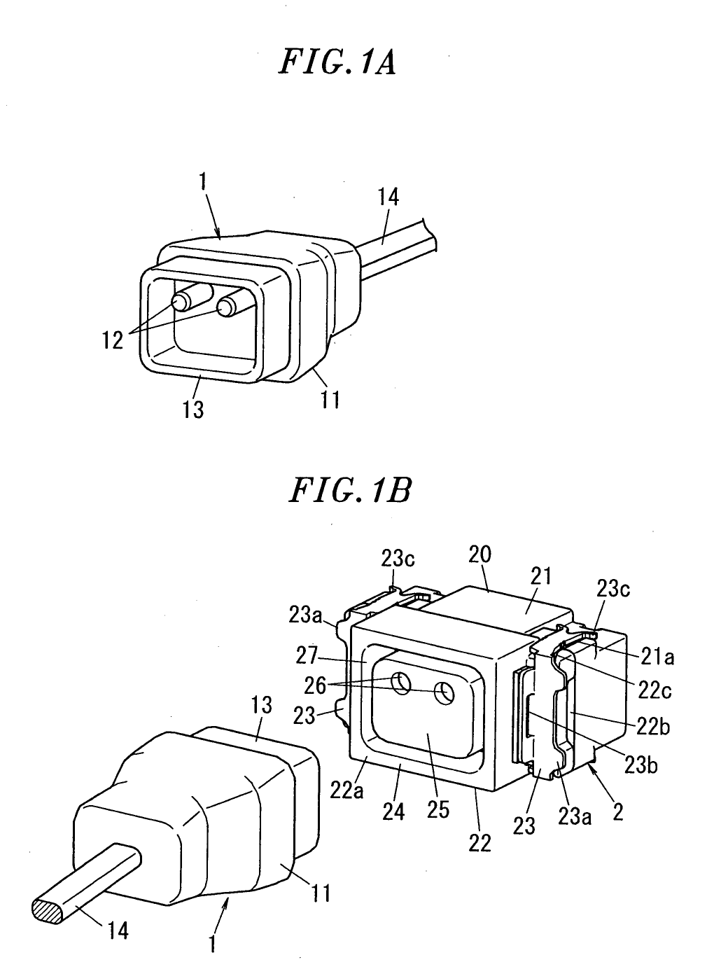

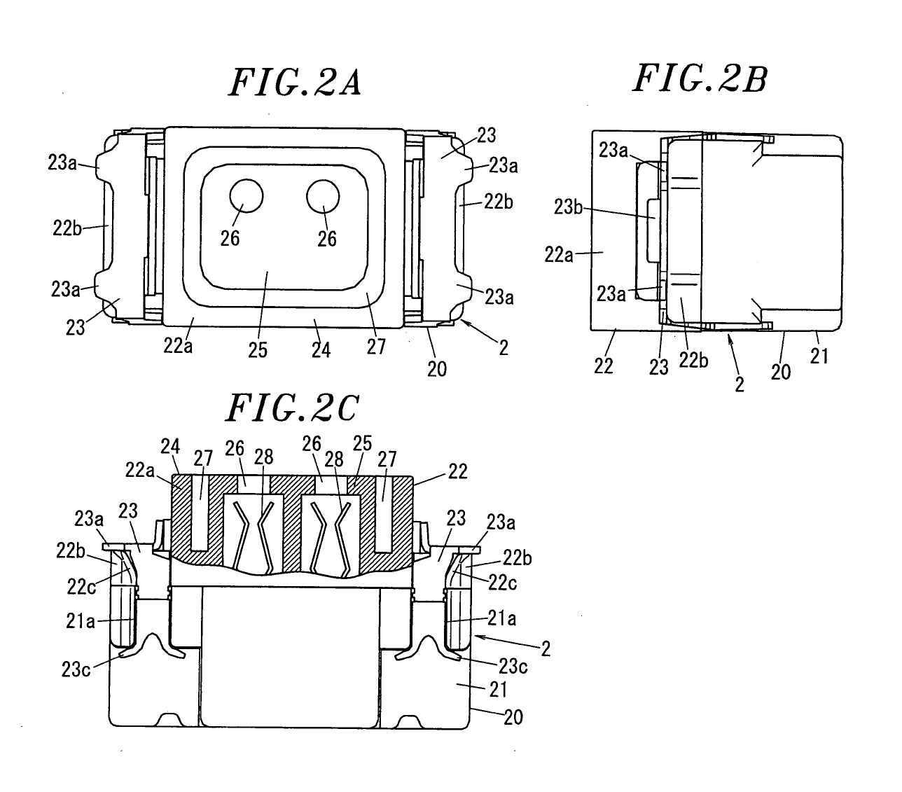

A first embodiment of the present invention will be described with reference to FIGS. 1A to 2C. A plug 1 in accordance with this embodiment is, e.g., detachably connected to a DC outlet 2 buried in a construction surface such as a wall. As shown in FIG. 1B, a plug connector for a DC power is constituted by the plug 1 and the DC outlet 2 which is connected to the plug 1 to supply a DC power thereto. Unless otherwise described, upward, downward, left and right directions of the plug 1 are defined based on FIG. 1A. The paper surface in FIG. 1A indicates the front side of the plug 1.

As illustrated in FIGS. 1A and 1B, the plug 1 includes a plug main body 11 having a horizontally elongated rectangular parallelepiped shape and a size which can be gripped by a user, the plug main body 11 being made of thermoplastic synthetic resin. Two round bar-shaped plug pins 12 to which power from the DC outlet 2 is supplied are protruded from a front surface of the plug main body 11 (the surface facing the DC outlet 2). A surrounding wall 13 is formed as a unit with the plug main body 11 and is protruded therefrom to surround the two plug pins 12. Further, an electric wire 14 of a load device extends from a rear surface of the plug main body 11. Hence, when the plug 1 is connected to the DC outlet 2, the DC power is supplied to the load device through the electric wire 14.

The surrounding wall 13 protruding from the front surface of the plug main body 11 is formed in a substantially quadrangular shape as viewed in a plug insertion direction (from the front side). The two plug pins 12 are arrange along a reference surface corresponding to one inner surface (e.g., upper inner surface) of the surrounding wall 13 and offset closer to the reference surface than to an inner surface (lower inner surface) opposite to the reference surface. Moreover, in this embodiment, a distance between the plug pins 12 and the upper inner surface of the surrounding wall 13 is ½ or less of a distance between the plug pins 12 and the lower inner surface of the surrounding wall 13, so that the plug pins 12 which are offset closer to the upper side can be easily recognized. In addition, a distance between the front surface of the plug main body 11 and the leading end of the surrounding wall 13 is set to be slightly larger than a distance between the front surface of the plug main body 11 and leading ends of the plug pins 12.

Meanwhile, as shown in FIGS. 1B and 2, the DC outlet 2 to which the plug 1 is detachably connected includes a outlet main body 20 made of synthetic resin and buried in a construction surface. The outlet main body 20 has a substantially box-shaped body 21 having an open front portion and made of synthetic resin and a substantially box-shaped cover 22 having an open rear portion and made of synthetic resin. The body 21 and the cover 22 can be assembled to each other by assembly frames 23 made of a metal.

The outlet main body 20 has a size conforming to Japanese Industrial Standard (see JIS C 8303). The outlet main bodies 20 has one module dimension, and three outlet main bodies can be attached side by side to a mounting frame for interchanging wring devices of large square boss type (see JIS C 8375).

Although an outlet fixed to a fixture is described as an example of the DC outlet 2 connected to the plug 1, the plug 1 may be connected to an outlet fixed to an electric device, a cord connector body used for extension connection of a cord without being fixed, a unfixed multi-outlet power strip and the like.

On a front surface of the cover 22, a boss 22a is forwardly protruded therefrom as a single unit to be fixed in an opening of a mounting frame (not shown). A central portion of the substantially U-shaped assembling frame 13 is mounted in each of shoulders 22b provided at opposite end sides of the boss 22a. Opposite end sides of the assembling frame 23 are respectively inserted into engaging recesses 22c and 21a formed at side surfaces of the cover 22 and the body 21, and substantially V-shaped engaging claws 23c provided at leading end portions of the opposite end sides of the assembling frame 23 are respectively expanded to be engaged with the opposite end portions of the engaging recess 21a. Accordingly, the body 21 and the cover 22 are combined by the assembling frame 23.

Protrudently provided at an outer peripheral portion of a central portion of the assembling frame 23 is a pair of engaging claws 23a capable of being engaged with engaging openings provided on the mounting frame made of a synthetic resin material. Further, engaging openings 23b are provided at a protruding portion forwardly protruding from an inner peripheral portion of the central portion of the assembling frame 23 to be engaged with engaging claws of a mounting frame (not shown) made of a metal material when being installed in the mounting frame.

Provided on a front surface of the boss 22a is an outlet unit 24 to which the plug 1 is detachably connected. Specifically, the outlet unit 24 is provided at a central portion of the front surface of the boss 22a. The outlet unit 24 has a substantially quadrangular shape viewed from the front thereof and includes a plug-receiving portion 25 in which two circular pin-inserting holes 26 are formed; an insertion groove 27 formed to surround the plug-receiving portion 25 so as to receive a surrounding wall 13 of the plug 1; and two pin-receiving pieces 28 for being respectively engaged with plug pins 12 of the plug 1 inserted into the outlet main body 20 through the pin-inserting holes 26.

Specifically, the two pin-inserting holes 26 are provided to correspond to the two (positive and negative) pin-receiving pieces 28 for supplying a DC power. The pin-inserting holes 26 are arranged along a side, e.g., an upper side, in the present embodiment, serving a reference side KL, of the plug-receiving portion 25 and closer to the upper side (the reference side KL) of the plug-receiving portion 25 than a lower side thereof opposite to the reference side KL.

Received into the outlet main body 20 are connection terminals (not shown) of so-called quick connection terminal structure to be respectively electrically connected to the pin-receiving pieces 28. A power supply line (not shown) of a DC power supply is inserted through a line-inserting hole opened at a rear side of the body 21 to be connected to the connection terminal. Further, the conventional quick connection terminal disclosed in the Japanese Patent Application Publication No. H10-144424, for example, may be employed as the connection terminals (not shown) of quick connection terminal structure, and the description and illustration thereof will be omitted.

When the plug 1 is connected to the DC outlet 2, the plug 1 first approaches the DC outlet 2 such that the plug pins 12 are aligned with the pin-inserting holes 26. Then, the surrounding wall 13 of the plug 1 is inserted into the insertion groove 27 of the DC outlet 2, and the plug pins 12 are fitted into the pin-inserting holes 26. Thereafter, the plug 1 continuously reaches a predetermined position to thereby engage the plug pins 12 with the pin-receiving pieces 28 electrically and mechanically. In addition, when the plug pins 12 are engaged to pin-receiving pieces 28, the front end portion of the surrounding wall 13 has been inserted into the insertion groove 27. Accordingly, even when an arc is generated during the engagement of the plug pins 12, the generated arc is not seen from the outside.

When the plug 1 is disconnected from the DC outlet 2, the plug 1 is first gripped and pulled out. Then, the plug pins 12 are disengaged from the pin-receiving pieces 28 and the pin-inserting holes 26. Thereafter, the surrounding wall 13 of the plug 1 is separated out from the insertion groove 27, to thereby disconnect the plug 1 from the DC outlet 2 easily. In addition, when the plug pins 12 are disengaged from the pin-receiving pieces 28, the leading end of the surrounding wall 13 has still been inserted into the insertion groove 27. Accordingly, even when an arc is generated during the disengagement of the plug pins 12, the generated arc is not seen from the outside.

In the plug 1 of this embodiment, the surrounding wall 13 has a substantially quadrangular shape viewed from the front side (in the plug insertion direction), and the two plug pins 13 are arranged along a reference surface corresponding to one inner surface (upper inner surface) of the surrounding wall 13 and offset closer to the reference surface than to the inner surface (lower inner surface) opposite to the reference surface. Hence, the orientation of the plug 1 to be inserted into the DC outlet 2 can be easily recognized.

Since the substantially quadrangular-shaped surrounding wall 13 is inserted into the insertion groove 27 formed around the quadrilateral plug receiving portion 25, the orientation of the plug 1 to be inserted into the DC outlet 2 is limited. This allows the position of the plug 1 and that of the DC outlet 2 to be easily aligned. Accordingly, the plug 1 which is convenient in use and has a configuration that prevents reverse insertion can be realized.

Unlike the aforementioned plug used for an SELV circuit specified in IEC standard which is provided with reverse insertion preventing ribs, the plug main body 11 has on the front surface thereof the surrounding wall 13 formed around the plug pins 12. Therefore, the plug 1 can have a simple shape, and it is unnecessary to scale up the plug 1 to ensure strength.

When the surrounding wall 13 has a cylindrical shape viewed in the plug insertion direction (from the front side), if the two plug pins 12 are arranged offset closer to one side of the surrounding wall 13, the gap between the two plug pins 12 decreases. However, in this embodiment, the surrounding wall 13 has a substantially quadrangular shape viewed in the plug insertion direction. Therefore, even if a plurality of (e.g., two in this embodiment) plug pins 12 is arranged offset closer to the reference surface, the gap between the plug pins 12 is not decreased. As a consequence, it is unnecessary to scale up the plug for socket 1 to ensure an insulation distance.

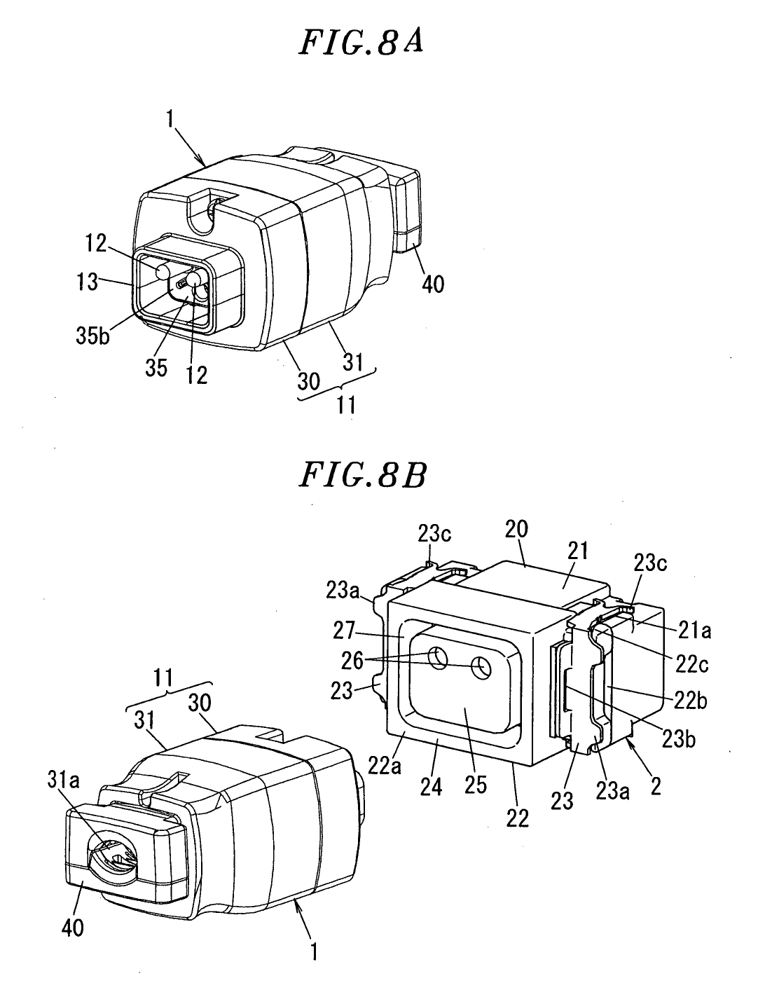

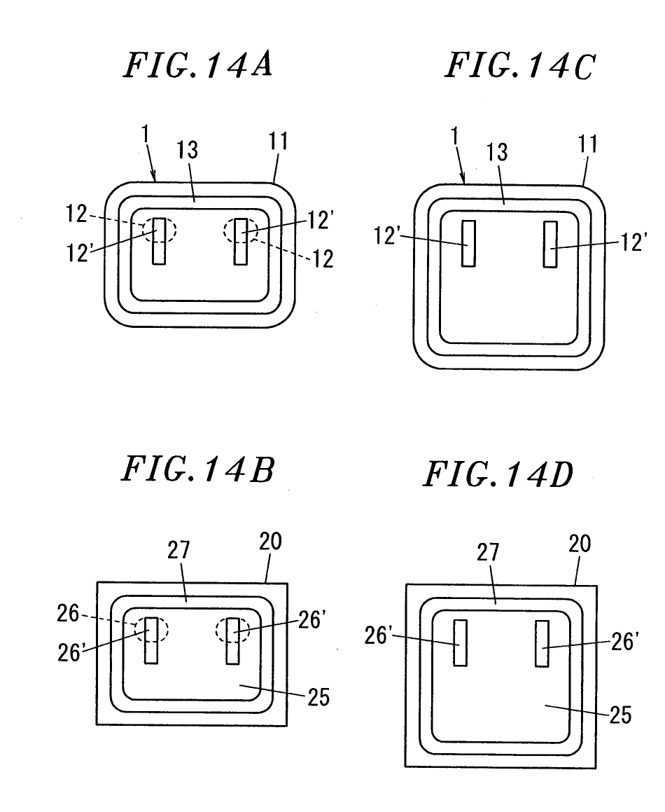

In the above-described plug connector, the plug 1 may be provided with flat plug blades instead of the round bar-shaped plug pins 12, and the plug receiving portion 25 may be provided with rectangular pin insertion holes. In that case, a vertical size of the flat plug blades becomes greater than that of the round bar-shaped plug pins 12 in order to have the same cross sectional area. As a consequence, a vertical size of pin insertion holes 26′ formed at the plug receiving portion 25 is greater than that of the round pin insertion holes 26, as can be seen from FIG. 8A. When the outlet main body 20 has a size of one module dimension, a difference between the vertical sizes of the pin insertion holes 26′ and the plug receiving portion 25 is small. Hence, even if the pin insertion holes 26′ are arranged offset closer to the upper side with respect to the center of the plug receiving portion 25, the offset amount of the pin insertion holes 26′ does not increase. This makes it difficult to discriminate whether the pin insertion holes 26′ are arranged offset closer to the upper side or the lower side. As for the plug 1 as well, it is difficult to determine whether the flat plug blades are offset closer to the upper side or the lower side. Moreover, the vertical size of the pin insertion holes 26′ is greater than that of the flat plug blades. Therefore, if the vertical offset amount of the pin insertion holes 26′ is small, the ends of the flat plug blades may be inserted into the pin insertion holes 26′ when the plug 1 is connected in a reverse orientation. To that end, it is required to increase the vertical offset amount of the opening positions of the pin insertion holes 26′ as shown in FIG. 14B. In the plug 1 as well, the vertical size of the plug main body 11 and the vertical offset amount of the flat plug blades need to be increased, which leads to scaling up of the outlet main body 20 or the plug 1. Therefore, in this embodiment, the plug pins 12 are formed in a round bar shape, and the pin insertion holes 26 are formed in a round hole shape. This can increase the vertical offset amount of the plug pins 12 compared to the case that the plug pins are formed in a flat-blade shape, so that it is possible to easily recognize whether the plug pins 12 are offset closer to the upper side or the lower side. As a result, incorrect (reverse) insertion of the plug 1 into the pin insertion holes 26 can be prevented.

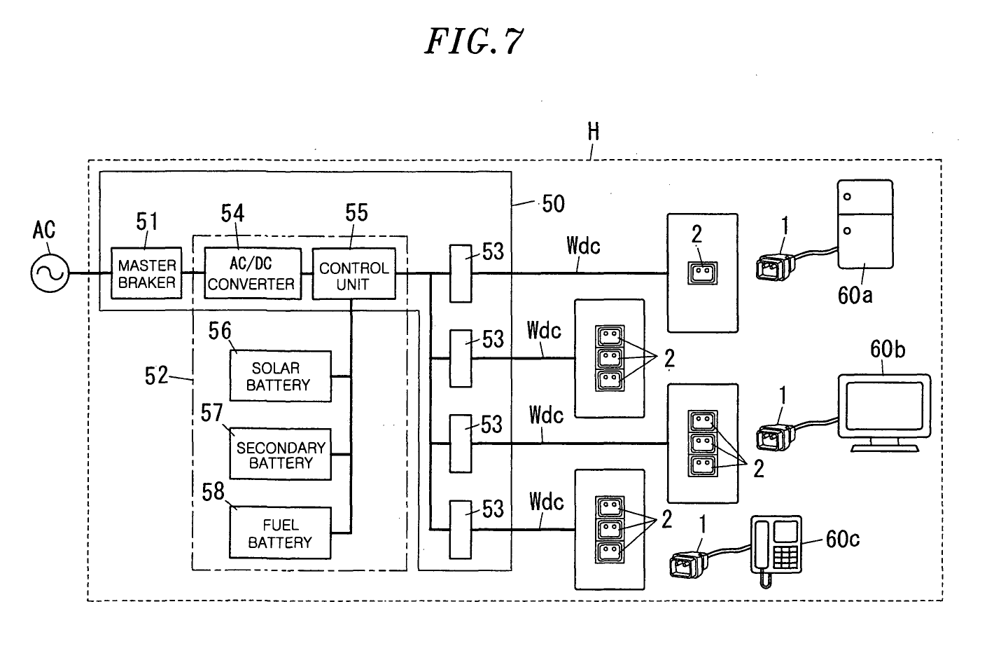

Meanwhile, the DC outlet 2 of the present embodiment is employed in a DC power distribution system shown in FIG. 7. FIG. 7 shows an example in which the DC power distribution system is applied to a detached house H. Alternatively, the DC power distribution system may be applied to a multi-family attached house or a building such as a tenant building.

In the house H, a DC power supply unit 52 for outputting a DC power; the DC outlets 2, provided at necessary positions, to which a DC power is supplied through DC supply lines Wdc; and a plurality of electric devices (e.g., a refrigerator 60a, a TV 60b, and a phone 60c) that are operated by the DC power are installed. The DC power is supplied to the electric devices 60a to 60c by connecting outlet plugs of the electric devices 60a to 60c to the DC outlets 2. Further, DC breakers 53 are respectively provided between the DC power supply unit 52 and the DC outlets 2 in order to monitor currents flowing through the DC supply lines Wdc and restrict or interrupt the power supply from the DC power supply unit 52 to the DC outlets 2 through the DC supply lines Wdc when detecting an abnormality.

The DC power supply unit 52 typically converts into a DC power an AC power supplied from an AC power source AC, e.g., a commercial power source, outside the house H. In FIG. 7, the DC power supply unit 52 includes an AC/DC converter 54 and a control unit 55, and the AC power is inputted to the AC/DC converter 54 including a switching power source through a master breaker 51 provided in a power distributor 50. The converted DC power is inputted to the respective DC breakers 53 through the control unit 55.

The DC power supply unit 52 further includes a secondary battery 57 to prepare for a time during which no power is supplied from the AC power source AC (e.g., the blackout of the AC power source AC). A fuel battery 58 and/or a solar battery 56 for generating a DC power may be employed together in addition to the secondary battery 57. In this case, with respect to a major power source including the AC/DC converter 54 for generating a DC power by using an AC power supplied from the AC power source AC, the solar battery 56, the secondary battery 57 and/or the fuel battery 58 serve as decentralized power sources. In addition, each of the solar battery 56, the secondary battery 57 and the fuel battery 58 includes a circuit unit for controlling an output voltage. Further, the secondary battery 57 includes a circuit unit for controlling a charging as well as the circuit unit for controlling an output voltage.

The electric devices 60a to 60c need a plurality of kinds of voltages depending on device types. For that reason, the control unit 55 preferably includes a DC/DC converter for converting a specific voltage supplied from the major and the decentralized power sources into necessary voltages to respectively supply the converted voltage to corresponding DC outlets 2. The supply voltages of the DC power may adequately be determined depending on the electric devices and/or the use environment of a building. Here, a power supply circuit of the power supply source for supplying a DC power to the DC outlet 2 is provided between the AC power supply source AC and the DC outlet 2, e.g., inside the power distributor 50.

### Second Embodiment

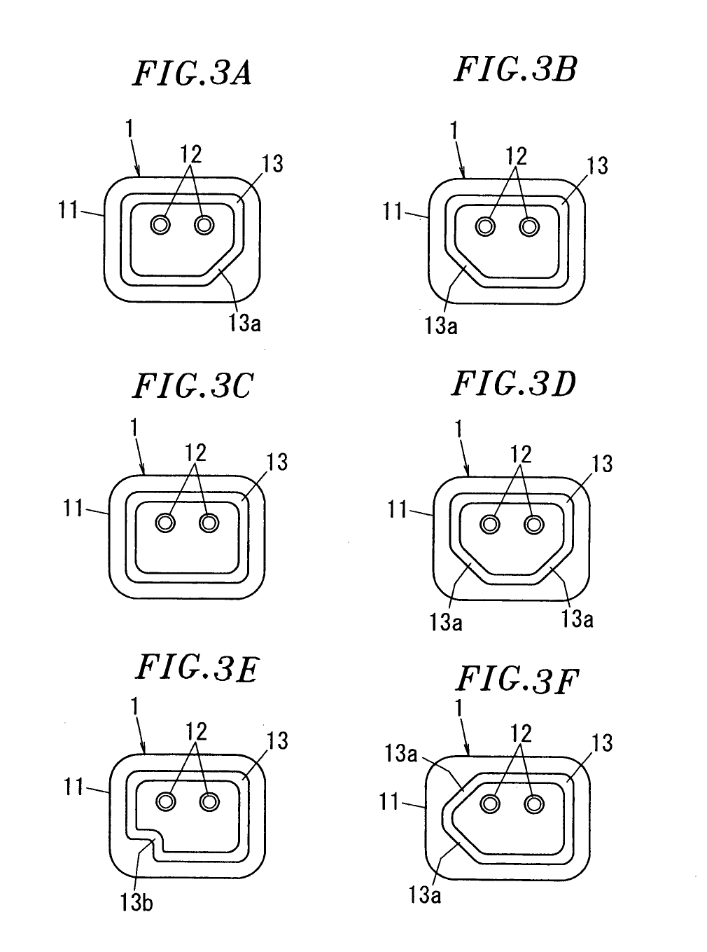

A second embodiment of the present invention will be described with reference to FIGS. 3A to 3F. The plug 1 of this embodiment is used for a plurality of supply voltages, and a shape of the surrounding wall 13 is partially changed depending on the kinds of supply voltages. The second embodiment is the same as the first embodiment except for the shape of the surrounding wall 13. Therefore, like parts are designated by like reference numerals, and redundant description thereof will be omitted.

The plug 1 of this embodiment is used for four DC supply voltages (e.g., about 6V, 12V, 24V and 48V). Thus, the shape of the surrounding wall 13 is partially changed depending on the kinds of the supply voltages.

FIGS. 3A to 3D provide front views of the plugs 1 used for 6V, 12V, 24V and 48V, respectively. In the plug 1 for 24V, the surrounding wall 13 has a substantially quadrangular shape viewed in the plug insertion direction (from the front side). In the plugs 1 for 6V, 12V and 48V, the shape of the surrounding wall 13 as viewed from the front side of the plug main body 11 is partially changed by cutting at least one corner of the surrounding wall 13 depending on the kinds of supply voltages. For example, in the plug 1 for 6V, an inclined portion 13a is formed by slantingly cutting the right lower corner of the surrounding wall 13. In the plug 1 for 12V, an inclined portion 13a is formed by slantingly cutting the left lower corner of the surrounding wall 13. In the plug 1 for 48V, inclined portions 13a are formed by slantingly cutting the right and the left lower corners of the surrounding wall 13. As the shape of the surrounding wall 13 of the plug 1 is changed, the shape of the insertion groove 27 of the DC outlet 2 is also changed depending on the kinds of supply voltages.

Among the plugs 1 for four voltages, the plug 1 for 24V has the surrounding wall 13 formed in a substantially quadrangular shape as viewed from the front side. In the plugs 1 for 6V, 12V and 48V, the shape of the surrounding wall 13 as viewed from the front side of the plug main body 11 is partially changed by cutting at least one corner of the surrounding wall 13. For that reason, a user can easily recognize the kinds of supply voltages from the shape of the surrounding wall 13 viewed from the front side. Further, the difference between the shapes of the surrounding wall 13 and the insertion groove 27 can be easily recognized, so that the position alignment of the plug 1 and the DC outlet 2 can be carried out. Since the shapes of the surrounding wall 13 of the plug 1 and the insertion groove 27 are partially changed depending on the kinds of supply voltages, the plug 1 can be prevented from being incorrectly connected to the DC outlet 2 for a different supply voltage. Accordingly, it is possible to prevent a DC voltage different from a rated voltage from being supplied to a load device.

In this embodiment, when the shape of the surrounding wall 13 is changed depending on the kinds of supply voltages, at least one corner of the substantially quadrangular shape is cut so as to reduce an area surrounded by the surrounding wall 13. This prevents outward extension of the surrounding wall 13 and, thus, scaling up of the plug 1 can be avoided. Although the corner of the surrounding wall 13 is slantingly cut in this embodiment, the corner may be cut in any shape. For example, an angular recess 13b may be formed by cutting the corner at a substantially right angle, as shown in FIG. 3E.

Further, when the corner of the substantially quadrangular shape is cut depending on the kinds of supply voltages, the lower corner(s) of the surrounding wall 13 is cut. Therefore, it is possible to obtain a sufficient distance between the plug pins 12 and the surrounding wall 13 compared with the case of cutting the upper corner near the reference surface (upper inner surface) close to the plug pins 12, and this enables easy fabrication of the plug 1. However, the corner near the reference surface of the surrounding wall 13 may be cut. Further, both of the upper corner (near the reference surface) and the lower corner (near the opposite surface to the reference surface) may be cut, as can be seen from FIG. 3F.

When the shape of the corner of the surrounding wall 13 is changed depending on the kinds of supply voltages, the position and the number of corners to be changed and the shape of changed portions can vary without being limited to those described in the above embodiment as long as the kinds of supply voltages can be identified.

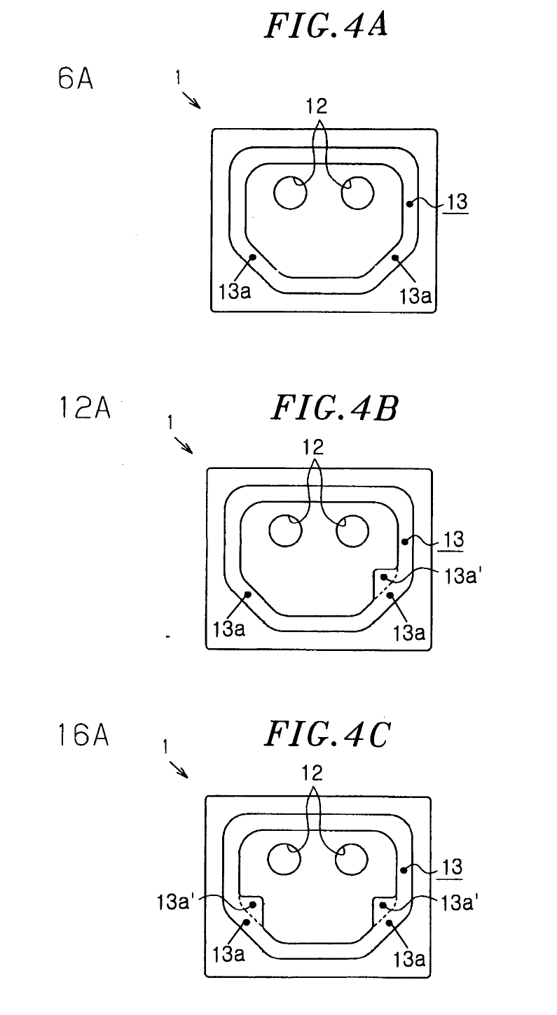

Further, in addition to or independently from the shape change of the surrounding wall 13 of the plug 1 depending on the kinds of supply voltages, the shape of the surrounding wall 13 of the plug 1 may be changed depending on the kinds of supply current, as shown in FIGS. 4A to 4C.

Referring to FIGS. 4A to 4C, the plug 1 for the supply voltage of 48V will be described as an example. There is a plurality of electronic devices requiring supply currents, e.g., 6, 12, 16A. Here, the shape of the surrounding wall 17 as viewed from the front thereof is changed by forming a rib or ribs on the inner surface thereof, to thereby make the plug 1 distinguishable depending on the kinds of the supplied current. In other words, based on the plug 1 for the supply current of 6A as shown in FIG. 4A, the rib(s) is provided to the plug 1 of the supply current of 12 and 16A.

Specifically, in the plug 1 for 12A as shown in FIG. 4B, a triangularly shaped rib 13a′ is provided at an upper portion of the inclined portion 13a by partially protruding the inclined portion 13a inwardly. Moreover, in the plug 1 for 16A as shown in FIG. 4C, the ribs 13a′ are provided at both of the upper portions of the inclined portions 13a. Meanwhile, in case the inclined portion 13a is not provided to the surrounding wall 13, the rib(s) may be formed to have the substantially quadrangular shape as viewed from the front thereof.

### Third Embodiment

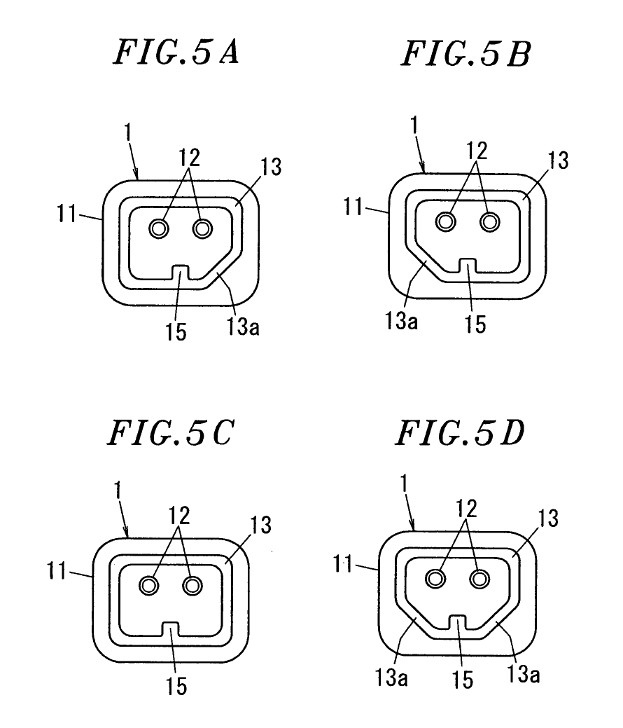

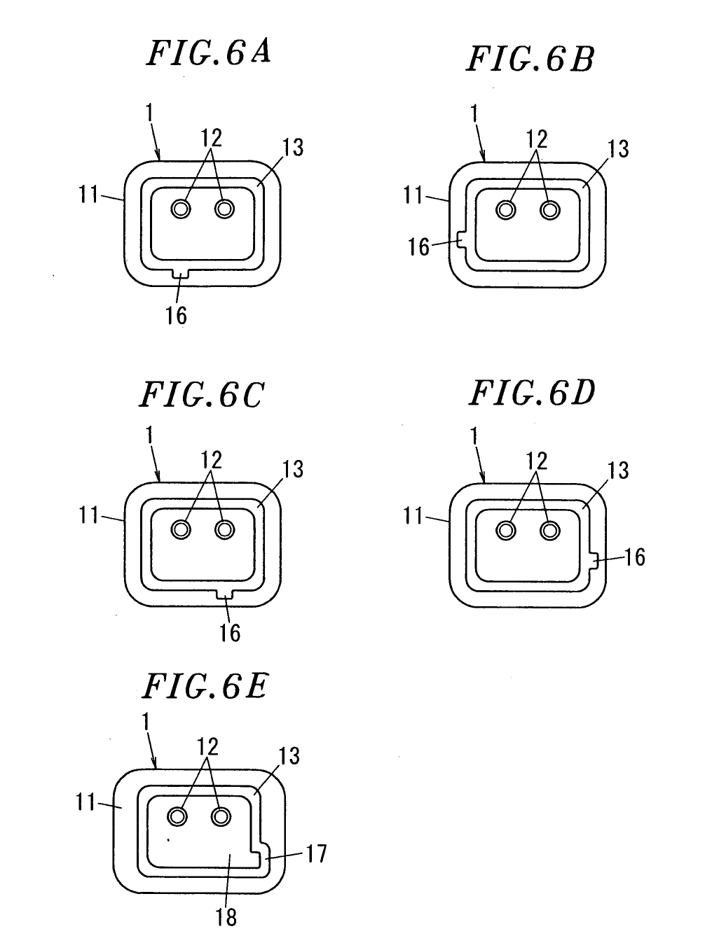

A third embodiment of the present invention will be described with reference to FIGS. 5A to 6E. In the second embodiment, the shape of the corner of the surrounding wall 13 is changed depending on the kinds of supply voltages. However, in the third embodiment, the shape of the surrounding wall 13 is partially changed by forming an extended portion protruding from the surface of the surrounding wall 13 depending on the kinds of power supply circuits serving as power supply sources. The third embodiment is the same as the second embodiment except for the shape of the surrounding wall 13. Hence, like parts are designated by like reference numerals, and description thereof will be omitted.

The power supply circuits serving as power supply sources, e.g., an SELV circuit, an ELV circuit, an FELV circuit and the like, are standardized in IEC standard. In a plug 1 used for an SELV circuit, an extended portion 15 protrudes inward from a lower central part of the surrounding wall 13, as illustrated in FIGS. 5A to 5D. FIGS. 5A to 5D show plugs for a socket 1 which handle 6V, 12V, 24V and 48V, respectively. As in the first embodiment, the shape of the surrounding wall 13 viewed from the front side of the plug main body 11 is partially changed by cutting at least one corner of the surrounding wall 13. In the power distribution system of FIG. 7, the power supply circuit serving as a power supply source is provided between the AC power supply and the DC outlet 2, e.g., inside the power distributor 50.

The plug 1 used for an ELV circuit is not provided with the extended portion 15, as shown in FIGS. 3A to 3D. Thus, the kinds of the power supply circuits can be easily recognized in accordance with existence/non-existence of the extended portion 15.

In the DC outlet 2 used for an SELV circuit, an identifying groove is formed to extend from the insertion groove 27 into the plug-receiving portion 25, the extended portion 15 being adapted to be fitted in the identifying groove. However, the DC outlet 2 used for an ELV circuit has on identifying groove. Therefore, the plug 1 used for an ELV circuit can be connected to both of the DC outlet 2 used for an ELV circuit and the DC outlet 2 used for an SELV circuit, whereas the plug 1 used for an SELV circuit 1 can be connected only to the DC outlet 2 used for an SELV circuit.

An insulation class of the SELV circuit is higher than that of the ELV circuit, so that a load device used in the SELV circuit (hereinafter, referred to as “SELV device”) does not require high insulation performance compared to a load device used in the ELV circuit (hereinafter, referred to as “ELV device”). Since the insulation performance of the SELV device is lower than that of the ELV device, when the SELV device having insufficient insulation performance compared to the ELV device is used in the ELV circuit whose insulation class is lower than that of the SELV circuit, breakdown caused by electric leakage or the like may occur. However, in this embodiment, the SELV device cannot be used in the ELV circuit. This is because the plug 1 used for an SELV circuit cannot be connected to the DC outlet 2 used for an ELV circuit and can be connected only to the DC outlet 2 used for an SELV circuit. Meanwhile, the ELV device can be connected to the DC outlet 2 used for an SELV circuit. When the ELV device is used in the SELV circuit, the above-described problem is not generated. This is because the ELV device has insulation performance higher than that of the SELV device and the insulation class of the SELV circuit is higher than that of the ELV circuit.

In the plug 1 of this embodiment, the extended portion 15 for identifying the kinds of power supply circuits protrudes from the surface of the surrounding wall 13, so that the strength of the extended portion 15 can be maintained compared to when the extended portion 15 is formed separately from the surrounding wall 1.

Moreover, the extended portion 15 protrudes inward from the inner surface of the surrounding wall 13. Thus, the plug 1 is not scaled up compared to when the extended portion 15 is formed at an outer portion of the surrounding wall 13.

Furthermore, the extended portion 15 formed at the inner surface of the surrounding wall 13 is disposed at the surface opposite to the reference surface (inner surface of upper wall) of the surrounding wall 13. Therefore, the distance between the extended portion 15 and the plug pins 12 can increase compared to when the extended portion 15 is disposed at the reference surface, and this enables easy fabrication of the plug 1. The position, the shape and the number of the extended portion are not limited to those of the above embodiment, and can be changed as long as the kinds of power supply circuits as power supply sources can be identified.

In the plug 1 depicted in FIGS. 5A to 5D, the shape of the surrounding wall 13 is partially changed by forming the extended portion 15 protruding inward from the inner surface of the surrounding wall 13 depending on the kinds of power supply circuits. However, the shape of the surrounding wall 13 can be partially changed by forming an extended portion 16 protruding outward from the outer surface of the surrounding wall 13, as shown in FIG. 6A. FIG. 6A shows a front view of the plug 1 used for an SELV circuit. The extended portion 16 shown in FIG. 6A protrudes outward from a lower left portion of the surrounding wall 13.

In the DC outlet 2 used for an SELV circuit which corresponds to this plug 1, an identifying groove (not shown) extends outward from the insertion groove 27, and the extended portion 16 is adapted to be fitted in the identifying groove. Meanwhile, the plug 1 used for an ELV circuit is not provided with the extended portion 16, and the DC outlet 2 used for an ELV circuit also has no identifying groove.

Therefore, the plug 1 used for an ELV circuit can be connected to both of the DC outlet 2 used for an ELV circuit and the DC outlet 2 used for an SELV circuit, whereas the plug 1 used for an SELV circuit can be connected only to the DC outlet 2 used for an SELV circuit. When the extended portion 16 protrudes outward from the outer surface of the surrounding wall 13, a space between the plug pins 12 and the surrounding wall 13 does not decrease, which enables easy fabrication of the plug 1.

The position, the shape and the number of the extended portion 16 are not limited to those in the above-described embodiment. The extended portion 16 may protrude outward from the lower portion of the left surface of the surrounding wall 13 as shown in FIG. 6B, or from the right portion of the lower surface of the surrounding wall 13 as shown in FIG. 6C. Or, the extended portion 16 may protrude outward from the lower portion of the right surface of the surrounding wall 13 as depicted in FIG. 6D.

In addition, the shape of the surrounding wall 13 may be changed so as to increase an area surrounded by the surrounding wall 13 by forming an enlarged portion 17, instead of the extended portion 15 or 16, at a part of the surrounding wall 13, as can be seen from FIG. 6E. In that case, the space between the plug pins 12 and the surrounding wall 13 does not decrease, which enables easy fabrication of the plug 1.

The shapes of the plug receiving portion 25 and the insertion groove 27 of the DC outlet 2 are also changed in accordance with the shape of the surrounding wall 13 of the plug 1 of this embodiment. The shapes of the plug receiving portion 25 and the insertion groove 27 of the socket 2 are described in PCT Application No. PCT/IB2010/001892 filed by the present Applicant, the contents of which are incorporated herein by reference.

### Fourth Embodiment

A fourth embodiment of the present invention will be described with reference to FIGS. 5 to 8. In the description of the fourth embodiment, like reference numerals will be used for the same components as those of the above-described embodiments, and redundant description thereof will be omitted.

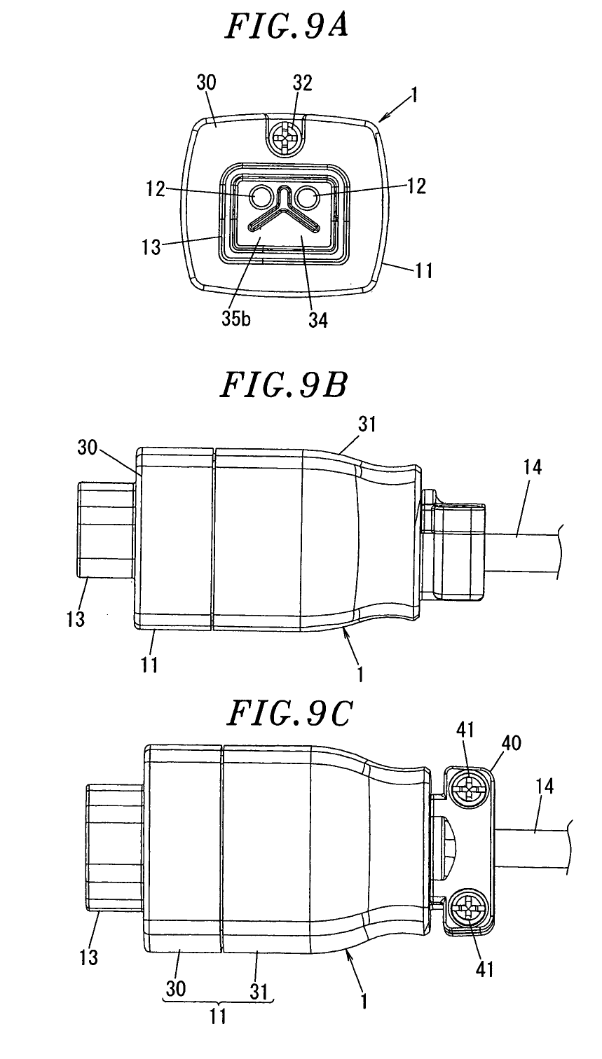

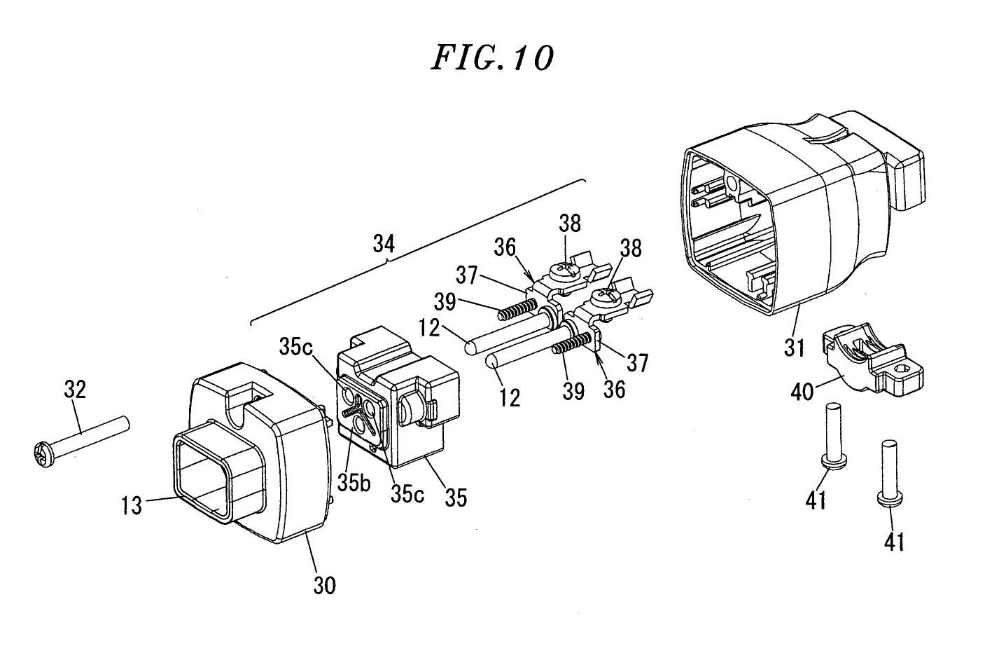

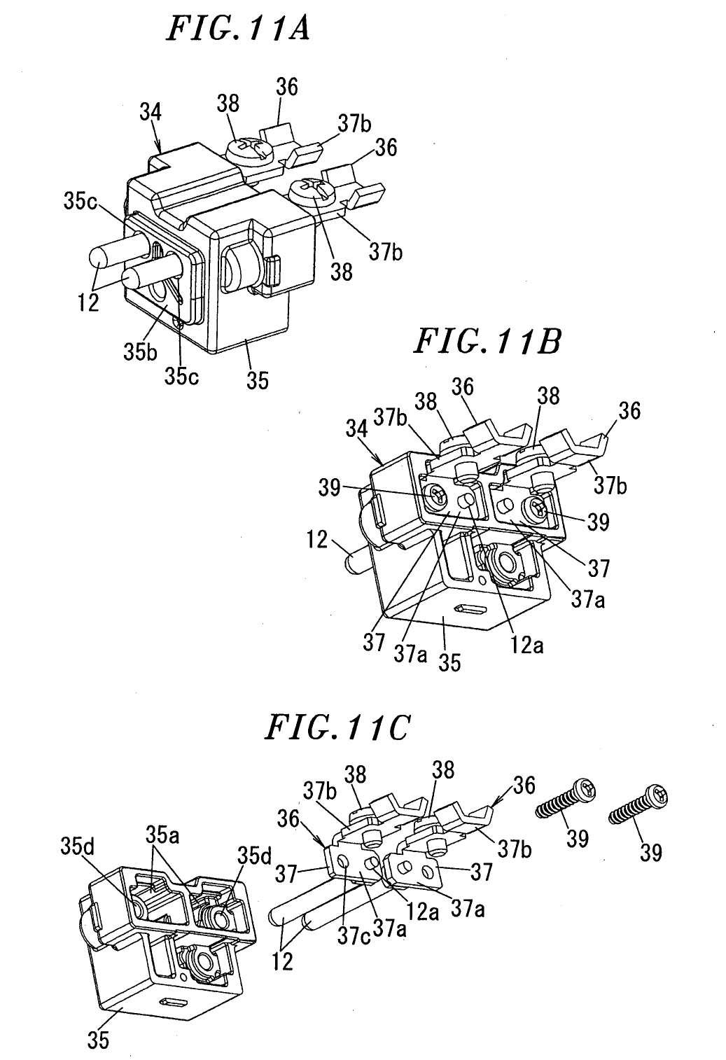

As shown in FIGS. 8 to 11, a plug main body 11 of a plug 1 of this embodiment is partitioned into two parts in the front-rear direction. The plug main body 11 has a size that can be gripped by a hand and includes: a box-shaped front case 30 made of synthetic resin and having an open rear portion; and a box-shaped rear case 31 made of synthetic resin and having an open front portion, which is fixed by screws 32 to the front case 30 so as to block the rear opening of the front case 30. The plug main body 11 accommodates therein a contactor block 34. In the contactor block 34, an electrode block 36 having a terminal plate 37 and two round bar-shaped plug pins 12 to which power from the DC outlet 2 is supplied is supported by an inner case 35 made of synthetic resin.

The two plug pins 12 protrude frontward from the front surface of the plug main body 11, i.e., the front surface of the front case 30 (the surface facing the DC outlet 2). The surrounding wall 13 is formed as a unit with the front case 30 so as to protrude therefrom and surround the two plug pins 12.

The surrounding wall 13 of the front case 30 has a substantially quadrangular shape viewed in the plug insertion direction (from the front side), and the central portion of the front surface of the inner case 35 is exposed through the inner portion of the surrounding wall 13. The two plug pins 12 are arranged along the reference surface corresponding to one inner surface (e.g., the upper inner surface) of the surrounding wall 13 and offset closer to the reference surface than to the inner surface (the lower inner surface) opposite to the reference surface. Moreover, in this embodiment, a distance between the plug pins 12 and the upper inner surface of the surrounding wall 13 is ½ or less of a distance between the plug pins 12 and the lower inner surface of the surrounding wall 13, so that the plug pins 12 offset close to the upper side can be easily recognized. Further, a distance between the front surface of the plug main body 11 and the leading end of the surrounding wall 13 is set to be slightly larger than a distance between the front surface of the plug main body 11 and the leading ends of the plug pins 12.

The inner case 35 has a substantially box shape having an open rear surface and is partitioned into a plurality of compartments 35a by a partition wall. The electrode block 36 is attached to each of the compartments 35a. A protruding table 35b is formed as a unit with the inner case 35 and protrudes frontward from the center of the front surface of the inner case 35 to be inserted into the surrounding wall 13 of the front case 30. The protruding table 35b has insertion through holes 35c opened correspondingly to the compartments 35a, so that the leading ends of the plug pins 12 protrude frontward through the insertion through holes 35c.

The terminal plate 37 of the electrode block 36 includes: a fixing piece 37a having an opening for fixing an axial portion 12a formed at the rear end portion of the plug pin 12; and a terminal piece 37b extending rearward from one side of the fixing piece 37a, the fixing piece 37a and the terminal piece 37b being formed as a unit. A core of the electric wire 14 from the load device is clamped and fixed between a terminal screw 38 and the terminal piece 37b. The axial portions 12a of the plug pins 12 are fixed to the openings of the fixing pieces 37a and, then, the plug pins 12 are inserted into the insertion through holes 35c from the rear portions of the compartments 35a of the inner case 35. Next, fixing screws 39, e.g., tapping screws, are inserted into insertion through holes 37c and coupled to fixing holes 35d of the inner case 35. As a consequence, the electrode block 36 is fixed to the inner case 35. When the electrode block 36 is fixed to the inner case 35, the leading end portions of the plug pins 12 protrude frontward through the insertion through holes 35c of the inner case 35.

In addition, an electric wire insertion through hole 31a is opened at the rear surface of the plug main body 11, i.e., the rear case 31, and the electric wire 14 of the load device which is inserted through the electric wire insertion through hole 31a is fixed by screws to the terminal plate 37 of the electrode block 36. When the contactor block 34 is accommodated in the front case 30, the rear case 31 is attached to the rear surface of the front case 30. By coupling the front case 30 and the rear case 31 by screws 32, the plug main body 11 is formed. When the assembly is completed, the plug pins 12 are positioned at the inner portion of the surrounding wall 13. Besides, an electric wire holding plate 40 for holding the electric wire 14 is fixed by screws 41 to the rear portion of the rear case 31 and reduces tension applied to the connection portion between the electric wire 14 and the terminal plate 37. When the plug 1 is connected to the DC outlet 2, the DC power is supplied to the load device via the electrode block 36 and the electric wire 14.

In case the plug main body 11 is partitioned into two parts horizontally or vertically, the surrounding wall 13 is not formed as a unit therewith and this decreases strength of the surrounding wall 13. Thus, when the plug main body 11 is attached to or detached from the DC outlet 2, the surrounding wall 13 may be broken. However, in this embodiment, the plug main body 11 is formed by coupling the front case 30 having the surrounding wall 13 and the rear case 31. Hence, the surrounding wall 13 can be formed as a unit with the plug main body 11, which increases the strength of the surrounding wall 13.

### Fifth Embodiment

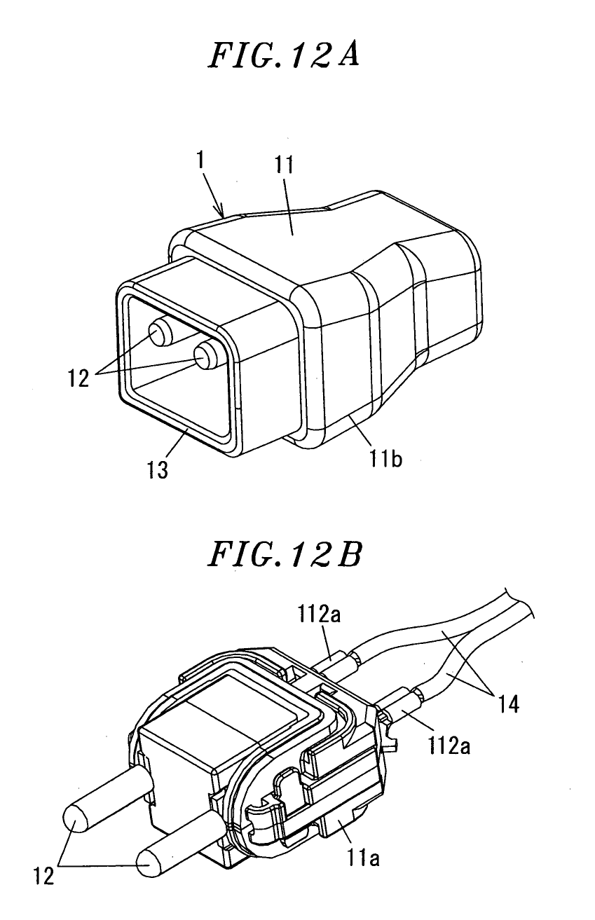

A fifth embodiment of the present invention will be described with reference to FIGS. 12A and 12B. In the description of the fifth embodiment, like reference numerals will be used for the same components as those of the above-described embodiment, and redundant description thereof will be omitted.

As illustrated in FIGS. 12A and 12B, the plug main body 11 includes: an inner case 11a (fixing portion) for fixing the two plug pins 12; and an outer case 11b (housing) formed at an outer side of the inner case 11a by a secondary molding and having a surrounding wall 13 formed as a unit therewith, the outer case 11b being made of synthetic resin. Terminals 112a electrically connected to the plug pins 12 protrude outward from the rear portion of the inner case 11a, and the core of the electric wire 13 is caulk-fixed to the terminals 112a. The terminals 112a are covered by resin when the outer case 11b is formed by the secondary molding, so that a charging portion is not exposed. The plug main body 11 can be simply assembled by forming the outer case 11b having the surrounding wall 13 at an outer portion of the inner case 11a for fixing the plug pins 12. Further, the inner case 11a fixes a plurality of (two in this embodiment) plug pins 12 spaced from each other at a predetermined interval while maintaining insulation property. In this embodiment, the plug pins 12 are supported by the inner case 11a made of synthetic resin. However, the inner case 11a may not be made of synthetic resin as long as the plug pins 12 are insulated from each other.

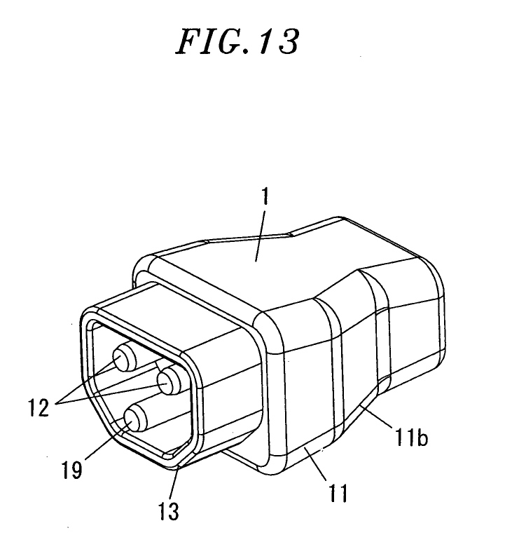

The plug 1 descried in the aforementioned embodiments has no ground electrode pin. However, as shown in FIG. 13, a ground electrode pin 19 may be provided in addition to the plug pins 12. Although FIG. 13 shows that the ground electrode pin is provided at the plug 1 of the fifth embodiment, the ground electrode pin 19 may be provided at the plug 1 of the other embodiments. In the plug 1 of FIG. 13, the ground electrode pin 19 is positioned at the apex of an isosceles triangle having the base connecting the two plug pins 12 serving as voltage electrodes. However, the position of the ground electrode pin 19 is not limited to that shown in FIG. 13.

While the invention has been shown and described with respect to the embodiments, it will be understood by those skilled in the art that various changes and modification may be made without departing from the scope of the invention as defined in the following claims.

What is claimed is:

1. A plug which is adapted to be connected to a direct current (DC) outlet for supplying a DC power thereto, the DC outlet having an insertion groove formed around a plurality of pin insertion holes opened at a front side and having therein pin-receiving pieces corresponding to the pin insertion holes, the plug comprising:
a plurality of round bar-shaped plug pins which protrudes from a front surface of a plug main body, the plug pins being adapted to be connected the pin-receiving pieces through the pin insertion holes of the DC outlet and to be supplied with power from the DC outlet; and
a surrounding wall which protrudes from the front surface of the plug main body to surround the plug pins, the surrounding wall being adapted to be inserted into the insertion groove of the DC outlet,
wherein the surrounding wall is formed in a substantially quadrangular shape, viewed from a front side thereof, and the plug pins are arranged along a reference surface corresponding to one inner surface of the surrounding wall and offset closer to the reference surface than to an inner surface opposite to the reference surface.

2. The plug of claim 1, wherein the shape of the surrounding wall, viewed from the front side, is partially changed depending on the kinds of a supply voltage or a supply current.

3. The plug of claim 2, wherein the shape of the surrounding wall viewed from the front side is changed such that an area of a portion surrounded by the surrounding wall compared to a case that the surrounding wall has the substantially quadrangular shape viewed from the front side.

4. The plug of claim 3, wherein the shape of the surrounding wall viewed from the front side is partially changed by cutting at least one corner of the substantially quadrangular shape of the surrounding wall depending on the kinds of the supply voltage or supply current.

5. The plug of claim 2, wherein a portion of the surrounding wall whose shape is changed depending on the kinds of the supply voltage or supply current is closer to the inner surface opposite to the reference surface than the reference surface.

6. The plug of claim 2, wherein the shape of the surrounding wall viewed from the front side is changed such that an area of a portion surrounded by the surrounding wall is increased as compared with a case that the surrounding wall has the substantially quadrangular shape viewed from the front side.

7. The plug of claim 2 or 4, wherein the shape of the surrounding wall viewed from the front side is partially changed by forming an extended portion protruding from a surface of the surrounding wall.

8. The plug of claim 7, wherein the extended portion extends inward from an inner surface the surrounding wall.

9. The plug of claim 7, wherein the extended portion is disposed closer to a surface opposite to the reference surface of the surrounding wall.

10. The plug of claim 7, wherein the extended portion extends outward from an outer surface of the surrounding wall.

11. The plug of claim 1, wherein the shape of the surrounding wall, viewed from the front side, is partially changed depending on the kinds of a power supply circuit serving as a power supply source.

12. The plug of claim 11, wherein the shape of the surrounding wall viewed from the front side is changed such that an area of a portion surrounded by the surrounding wall compared to a case that the surrounding wall has the substantially quadrangular shape viewed from the front side.

13. The plug of claim 12, wherein the shape of the surrounding wall viewed from the front side is partially changed by cutting at least one corner of the substantially quadrangular shape of the surrounding wall depending on the kinds of the power supply circuit.

14. The plug of claim 11, wherein a portion of the surrounding wall whose shape is changed depending on the kinds of the power supply circuit is closer to the inner surface opposite to the reference surface than the reference surface.

15. The plug of claim 11, wherein the shape of the surrounding wall viewed from the front side is changed such that an area of a portion surrounded by the surrounding wall is increased as compared with a case that the surrounding wall has the substantially quadrangular shape viewed from the front side.

16. The plug of claim 11 or 13, wherein the shape of the surrounding wall viewed from the front side is partially changed by forming an extended portion protruding from a surface of the surrounding wall.

17. The plug of claim 16, wherein the extended portion extends inward from an inner surface the surrounding wall.

18. The plug of claim 7, wherein the extended portion is disposed closer to a surface opposite to the reference surface of the surrounding wall.

19. The plug of claim 7, wherein the extended portion extends outward from an outer surface of the surrounding wall.

20. The plug of claim 11, wherein the shape of the surrounding wall viewed from the front side is partially changed only when the power supply circuit is a safety extra low voltage (SELV) circuit.

21. The plug of claim 1, wherein the plug pins of the plug include a ground pin.

22. The plug of claim 21, wherein the ground pin is provided offset closer to the inner surface opposite to the reference surface.

23. The plug of any one of claims 1, 2, 11 and 21, wherein the plug main body includes: a box-shaped front case having an open rear portion, the surrounding wall being provided on a front surface of the front case; and a box-shaped rear case having an open front portion, the rear case being fixed to the front case so as to block the rear opening of the front case, and wherein the plug pins are received in the front and the rear case.

24. The plug of any one of claims 1, 2, 11 and 21, wherein the plug main body includes: a fixing portion for fixing the plug pins; and a housing formed at an outer side of the fixing portion by a secondary molding, the housing being made of synthetic resin, and wherein the surrounding wall is formed as a unit with the housing.
